(19) United States
(12) Patent Application Publication
(10) Pub. No.: US 2015/0269875 A1
(43) Pub. Date: Sep. 24, 2015

(54) Alert Sign

(71) Applicants: Brendan William Corcoran, Ridgewood, NJ (US); Nicholas Vallo, New Albany, OH (US); Christos Ragias, New Albany, OH (US); Bret Gould, Worthington, OH (US); Kathryn Carlson, Columbus, OH (US)

(72) Inventors: Brendan William Corcoran, Ridgewood, NJ (US); Nicholas Vallo, New Albany, OH (US); Christos Ragias, New Albany, OH (US); Bret Gould, Worthington, OH (US); Kathryn Carlson, Columbus, OH (US)

(21) Appl. No.: 14/664,877

(22) Filed: Mar. 22, 2015

Related U.S. Application Data
(60) Provisional application No. 61/969,152, filed on Mar. 22, 2014.

(51) Int. Cl. G09F 13/00; H04R 1/02; G09F 7/18

(52) U.S. Cl. CPC G09F 13/00; G09F 7/18; H04R 1/028; G09F 2007/1843; G09F 2007/1873

(57) ABSTRACT

An illuminated display device is disclosed, comprising a housing with an illuminated inner volume. In one embodiment, the illuminated display device draws attention to the display via lights and sound, and provides textual and graphical information stored within the inner volume of the housing to provide emergency personnel and others with information related to the occupants, contents, and/or pets within a building during an emergency event.

### CROSS-REFERENCE TO RELATED APPLICATIONS

This application claims priority from U.S. Provisional Patent Application No. 61/969,152, filed on Mar. 22, 2014, which is incorporated by reference herein in its entirety.

### BACKGROUND

Signs are used to readily convey information to others. Illuminated signs have been used to focus attention on the information the sign conveys.

House pets are common household fixtures that use vocalizations that may not always be understood by humans. Signs are often used with pets to convey information about the pet to other humans. Signs such as “Beware of Dog,” “Dog in Yard, Keep Gate Closed,” and identification and medical tags on a pet's collar are examples of pet signs used to convey pet information to humans. An emergency situation may hinder a pet's vocalization so as to alert a human that the pet is in danger.

The ubiquity of alert signs may cause them to blend in with their environment, and illuminated signs may only be illuminated on a schedule (e.g., after dark), but not illuminated automatically in connection with an alarm condition (e.g., a smoke detector triggered within a building).

Accordingly, what is needed is an alert sign used to communicate information, including information about a pet and that a pet is in distress, during an emergency situation.

### SUMMARY

In one embodiment, an illuminated alert display is provided, the illuminated alert display comprising: a housing, the housing comprising a display portion thereon, the display portion operable to affix text and graphics thereto; a lighting device operatively connected to the housing, a power source operatively connected to the lighting device; and mounting hardware operatively connected to the housing.

In another embodiment, an alert sign is provided, the alert sign comprising: a housing, wherein the housing comprises an inner volume, the inner volume operable to house and display a graphic and/or a text, the housing further comprising a transparent surface overlying the inner volume such that the graphic and/or the text within the inner volume of the housing is visible from outside the housing through the transparent surface, and wherein the transparent surface is selectively engageable to the housing via a connection hardware, such that the connection hardware allows the transparent surface to be selectively removed from the housing to allow access to the inner volume; a lighting device connected to the housing; the lighting device operable to illuminate at least one of: the inner volume of the housing, an area external to the housing; a power source operatively connected to the lighting device, wherein the power source is housed on or in the housing; a circuit, wherein the circuit provides an electrical connection between the power source and the lighting device; a switch, the switch operatively connected to the circuit, the switch operable to control power from the power source to the lighting device so as to control an illumination of the lighting device; and a mounting hardware, the mounting hardware operatively connected to the housing and configured to visibly mount the alert sign such that the graphic and/or the text within the inner volume is visible.

In another embodiment, an alert sign is provided, the alert sign comprising: a housing, the housing comprising an inner volume, the inner volume operable to house and display a graphic and/or a text, the housing further comprising a transparent surface overlying the inner volume such that the graphic and/or the text within the inner volume of the housing is visible from outside the housing through the transparent surface, and wherein the transparent surface is attached to the housing by an attachment hardware such that the transparent surface is selectively removable from the housing so as to allow access to the inner volume; a lighting device operatively connected to the housing; the lighting device operable to illuminate at least one of: the inner volume of the housing, and an area external to the housing; a power source operatively connected to a circuit, wherein the power source is housed on or in the housing; a circuit, wherein the circuit interconnects at least the power source, the lighting device, a switch, a processor, a transceiver, and a speaker; a switch, the switch operatively connected to the circuit, the switch operable to control power from the power source to the lighting device so as to control an illumination of the lighting device; a processor, the processor operatively connected to the circuit, the processor further comprising a memory, wherein the processor and the memory are operable to store and execute one or more program embedded on any processor readable medium; a transceiver, the transceiver operable to transmit and/or receive a signal; a speaker, the speaker configured to output an audio signal; a mounting hardware, the mounting hardware operatively connected to the housing and configured to visibly mount the alert sign such that the graphic and/or the text within the inner volume is visible when the alert sign is mounted, wherein the mounting hardware is selectively engageable to the housing such that the mounting hardware may be positioned on different areas of the housing; the mounting hardware at least one of: a bracket; a recess; a hanging wire; a suction cup; a hook and loop fastener; a D-ring; and a hook, such that the mounting hardware attaches either to a corresponding external mounting hardware, or directly to an external surface.

### BRIEF DESCRIPTION OF THE DRAWINGS

The accompanying figures, which are incorporated in and constitute a part of the specification, illustrate various example systems and are used merely to illustrate various example embodiments.

FIG. 1 illustrates a front view of one embodiment of an alert sign.

FIG. 2 illustrates a front view of one embodiment of an alert sign.

FIG. 3A illustrates one embodiment of an alert sign insert.

FIG. 3B illustrates another embodiment of an alert sign insert.

FIG. 3C illustrates another embodiment of an alert sign insert

FIG. 4A illustrates a perspective view of an alert sign.

FIG. 4B illustrates a side view of an alert sign.

FIG. 5 illustrates a perspective view of an alert sign.

FIG. 6 illustrates a schematic view of an alert sign.

FIG. 7 illustrates an exploded, perspective view of one mounting embodiment for an alert sign.

FIG. 8 illustrates a perspective view of another mounting embodiment for an alert sign.

FIG. 9A illustrates a perspective view of another mounting embodiment for an alert sign.

FIG. 9B illustrates a perspective view of another mounting embodiment for an alert sign.

FIG. 10A illustrates a perspective view of another mounting embodiment for an alert sign.

FIG. 10B illustrates a front view of another mounting embodiment for an alert sign.

FIG. 10C illustrates a perspective view of another mounting embodiment for an alert sign.

FIG. 11 illustrates a rear view of another mounting embodiment for an alert sign.

FIG. 12 illustrates an example modular power arrangement for an alert sign.

### DETAILED DESCRIPTION

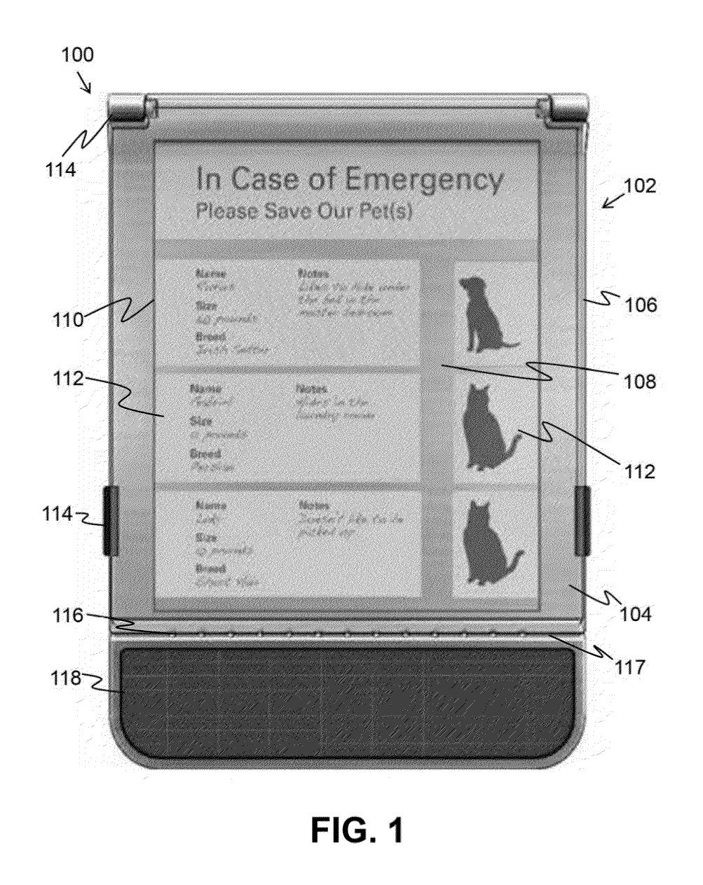

FIG. 1 illustrates a front view of an alert sign 100. In one embodiment, alert sign 100 may be used in emergency situations to alert emergency responders as to a pet's presence in a building to facilitate rescue of the pet. In another embodiment, alert sign 100 may be used as a warning sign to alert a presence of children, children playing, children in the street, and the like. In another embodiment, alert sign 100 may be used to alert users of a temporary detour or provide directions. In another embodiment, alert sign 100 may alert users as to available parking, a parking situation, parking directions, parking fees, and the like. In another embodiment, alert sign 100 may be used as a portable or permanent display and signage device to draw attention to texts and graphics on alert sign 100.

Alert sign 100 may comprise a housing 104 which operatively connects various components of alert sign 100. Alert sign 100 may have a display area 102 with an inner volume 110. The area defined by inner volume 110 may be used to post informational signs, text, and/or graphics 112 relating to house pets, or providing any of a variety of other information types. Inner volume 110 may be bounded by a back surface 108 of inner volume 110 and a transparent surface 106, such as a cover or lid.

Housing 104 may be any rugged material suitable for prolonged outdoor use such as metal, polymeric material, plastic, wood, and the like. In one embodiment, housing 104 is easily mass produced using a known manufacturing technique such as stamping or injection molding. Housing 104 may be one part or an assembly of different subassemblies.

In one embodiment, the front of housing 104 may be covered by transparent surface 106, such as a cover or lid. Cover or lid 106 may be transparent to allow a user to view informational signs, text and graphics 112 posted in inner volume 110 of display area 102. In one embodiment, cover or lid 106 is fully transparent about the whole surface of cover or lid 106. In another embodiment, cover or lid 106 is only partially transparent allowing a user to see only into inner volume 110. Cover or lid 106 may be partially covered with transparent areas and may be processed by frosting or etching to draw attention to cover or lid 106 or provide illuminative effects to cover or lid 106 in the presence of light. Cover or lid 106 may be one part or an assembly of separate parts, such as an opaque frame and a transparent glass or polymer insert.

Cover or lid 106 may be any rugged material suitable for prolonged outdoor use, such a polymeric material, plastic, glass or the like. In one embodiment, cover or lid 106 may be an acrylic material such as Plexiglas®. In another embodiment, cover or lid 106 may be a thermoplastic such as Lexan™. In another embodiment, cover or lid 106 may be a rugged glass material such as a borosilicate glass. Cover or lid 106 may be easily manufactured using known manufacturing techniques such as injection molding, extrusion, glass forming, and the like.

Inner volume 110 is bounded by cover or lid 106 and back surface 108. In one embodiment, back surface 108 is opaque to provide a good contrast for viewing informational signs, text, and graphics 112. Back surface 108 may be part of housing 104 or a separate insert that connects to housing 104. In one embodiment, back surface 108 has a surface treatment to make back surface 108 more tacky to facilitate a better mounting of informational signs, text, and graphics 112. In another embodiment, back surface 108 or parts of housing 104 adjacent to back surface 108 has slots or other similar features machined into portions of their surfaces to provide an attachment point for informational signs, text, and graphics 112. In another embodiment, back surface 108 is partially or fully magnetized to interact with magnetized or ferromagnetic, or paramagnetic informational signs, text and graphics 112 to facilitate a mounting thereof. In another embodiment, back surface 108 has a connection hardware such as a hook and loop fastener to interface with a hook and loop fastener on informational signs, text, and graphics 112 to facilitate a mounting thereof. In another embodiment, back surface 108 has a surface treatment such as corkboard to allow a mounting of informational signs, text, and graphics 112 with a nail, brad, pushpin, pin, staple, and the like.

Housing 104 may have one or more connection hardware 114 to facilitate a connection between cover or lid 106 and housing 104. Connection hardware 114 may be part of housing 104, part of cover or lid 106, a combination of both, or independent of each. In one embodiment, connection hardware 114 is one or more hinges used to hingedly attach cover or lid 106 to housing 104. In another embodiment, connection hardware 114 is one or more latches on cover or lid 106 and/or housing 104 to secure cover or lid 106 to housing 104. In another embodiment, cover or lid 106 is a press fitting, a hook and loop fastener, a selectively removable adhesive, a magnet, a zipper, or like chemical or mechanical fastener used to fixedly secure cover or lid 106 to housing 104. In one embodiment, connection hardware 114 may include a lock such that cover or lid 106 is lockable relative to housing 104 so as to prevent cover or lid 106 from being selectively removed from housing 104 to prevent access to informational signs, text and graphics 112 within inner volume 110.

One or more lighting devices 116 may be disposed about housing 104 to provide illumination to informational signs, text, and graphics 112 within inner volume 110. In one embodiment, lighting devices 116 are used to illuminate an area external to housing 104. Lighting devices 116 may be situated in different areas on housing 104 depending on their lighting function. For example, lighting devices 116 may be located adjacent to inner volume 110 to provide illumination to inner volume 110. In another embodiment, lighting devices 116 may be embedded in back surface 108 to provide back lighting to inner volume 110. In another embodiment, lighting devices 116 are mounted on shelf 117 of housing 104 to provide illumination to inner volume 110. In another embodiment, lighting devices 116 are mounted on housing 104 to project light externally from housing 104 so as to draw attention to alert sign 100.

Lighting devices 116 may be any commonly used lighting devices, such as: light emitting diodes (LEDs), incandescent lights, fluorescent lights, and the like. In one embodiment, lighting device 116 is a cost effective, low power consuming, rugged light meant for outdoor environments such as an LED. In another embodiment, lighting device 116 is an LED capable of illuminating in more than one color of light, such as red and white. Lighting device 116 may flash, blink, or otherwise operate in a pattern to draw attention to alert sign 100.

Lighting devices 116 may be powered by a power source (not shown). One or more solar cells, such as photovoltaic (PV) panel 118, may be used to power lighting devices 116 as a power source alone, or charge another power source such as a battery (not shown) used to power lighting devices 116. PV panel 118 may be situated about housing 104 in a location so as to best convert solar radiation into electricity. Other power sources may include batteries, rechargeable batteries, a wired connection to a line voltage from an electrical outlet, and the like.

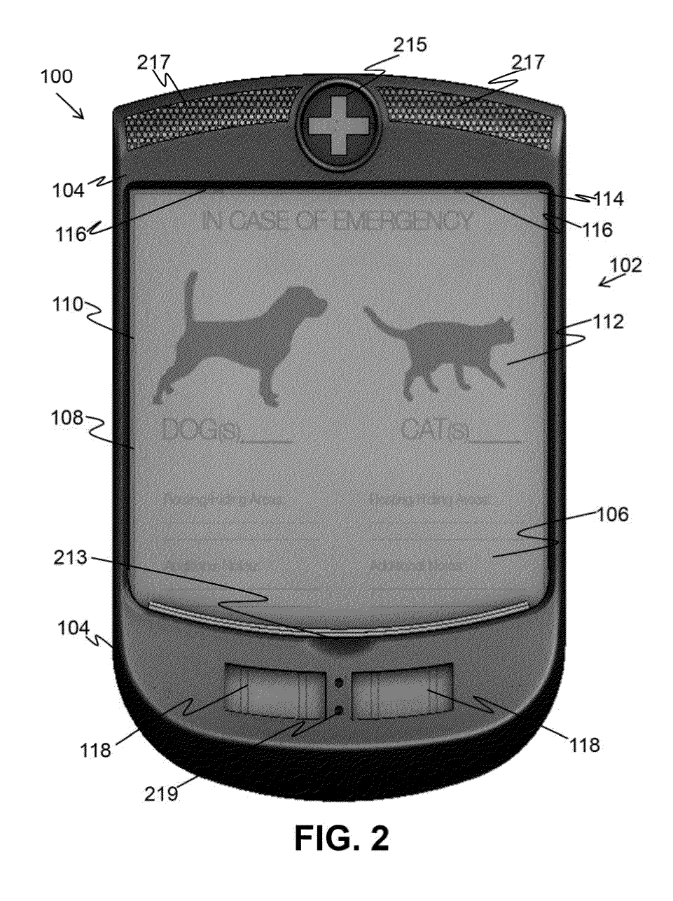

Referring to FIG. 2, a front view of one embodiment of alert sign 100 is shown. In one embodiment, housing 104 of alert sign 100 includes indentation 213 to assist in lifting lid 106. In addition to lighting devices 116 which may be used to illuminate informational signs, text, and graphics 112 within inner volume 110, housing 104 may include alert light 215. Alert light 215 may illuminate if triggered by a triggering event, an alert condition, or alert signal. In one embodiment, alert light 215 blinks if triggered by a triggering event, an alert condition, or alert signal to draw attention to alert sign 100. In another embodiment, alert light 215 illuminates when triggered by a photo sensor 219. Photo sensor 219 may detect lighting levels and automatically illuminate lighting devices 116 and alert light 215 when light drops below a predetermined level. Alert light 215 may be constantly illuminated at a dim level and brighten when an alert condition is triggered. Alert light 215 may be constantly illuminated in light and dark conditions. Alert light 215 may be constantly blinking to draw attention to alert sign 100. In one embodiment, alert light 215 is of a reflective material such that alert light 215 doubles as a reflective surface to draw attention to alert sign 100. In another embodiment, alert light 215 includes a replaceable graphic that can be replaced by another graphic depending on alert sign 100 use. For example, a cross illustrated on alert light 215 in FIG. 2 may be replaced by an exclamation mark, children playing graphic, “P” for parking, an animal graphic, a traffic sign warning or graphic, and like warning and informational graphics. Alert sign 100 may also include reflective material 217. Reflective material 217 may be a plastic reflector, a reflective sticker or tape, a reflective paint, and like reflective treatment. Reflective material 217 may be used to draw attention to alert sign 100 when light is shined toward alert sign 100. Reflective material 217 may additionally include illumination functionality. In another embodiment, reflective material 217 may be phosphorescent to prove glow-in-the-dark functionality.

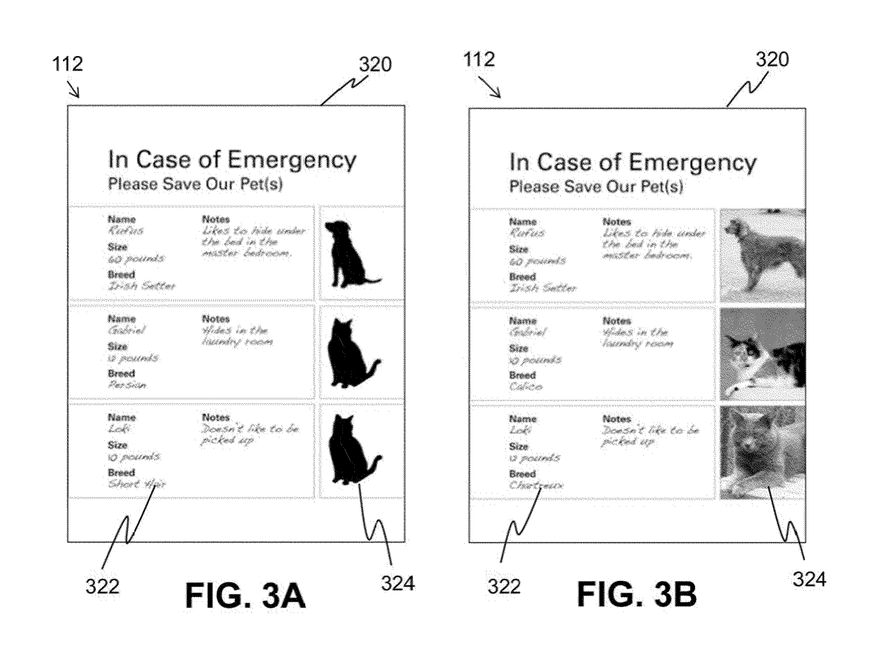

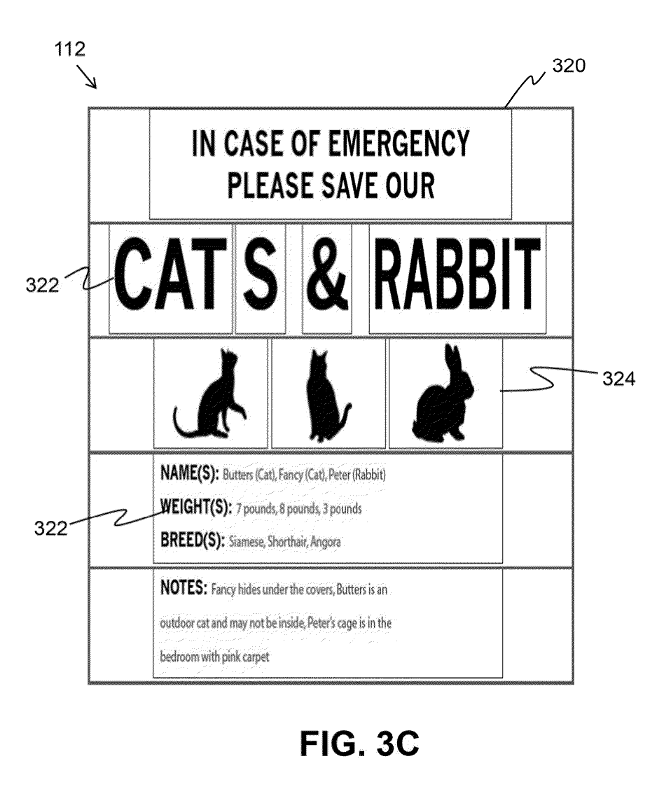

With reference to FIGS. 3A, 3B, and 3C, informational signs, text, and graphics 112 are generally shown. Informational signs, text, and graphics 112 may be one pre-printed sign 320 containing pet information thereon. Sign 320 may contain information pertaining to one or more pets such as: name, size, breed, emergency instructions, notes about the pet, and the like. Sign 320 may include text 322 and graphics 324. In one embodiment, sign 320 may be an assembly of movable text 322 and graphics 324 so as to provide a dynamic alert sign 100 which allows for the addition of pets and removal of pets. In this embodiment, a user may arrange text 322 and graphics 324 to his/her choosing to highlight certain information or pet(s). In one embodiment, graphics 324 may be a generic representation of a pet such as a dog, cat, rabbit, bird, etc. In another embodiment, graphics 324 may be an actual picture or representation of the pet. One or more portions of 320 may include pre-printed text or space to allow for a user to manually enter text. Sign 320 may have a surface treatment such as a dry-erase surface or the like to allow for a user to add and remove text from sign 320. As mentioned above, informational signs, text, and graphics 112 may include hardware or surface treatments to facilitate mounting to back surface 108 or housing 104 in inner volume 110 of alert sign 100. For example, back surface 108 may be ferromagnetic such that text 322 and graphics 324 may be magnetized so as to easily attach to, and be arranged on back surface 108. Likewise, back surface 108 may be magnetized such that text 322 and graphics 324 on metal material may magnetically attach to back surface 108. Sign 320 may be cut to a determined size or thickness to best interface with back surface 108 of inner volume 110. Informational signs, text, and graphics 112 may be displayed on any of a plastic, wood, metal, composite, paper material, and the like. In one embodiment, informational signs, text, and graphics 112 may be displayed on an electric display such as a thin film display such as an LCD or LED display.

In one embodiment, sign 320 may convey any type of information, including for example emergency information pertaining to occupants of a building or home, employees in a building, information on gatherings, alerts regarding fire or other emergencies, and the like.

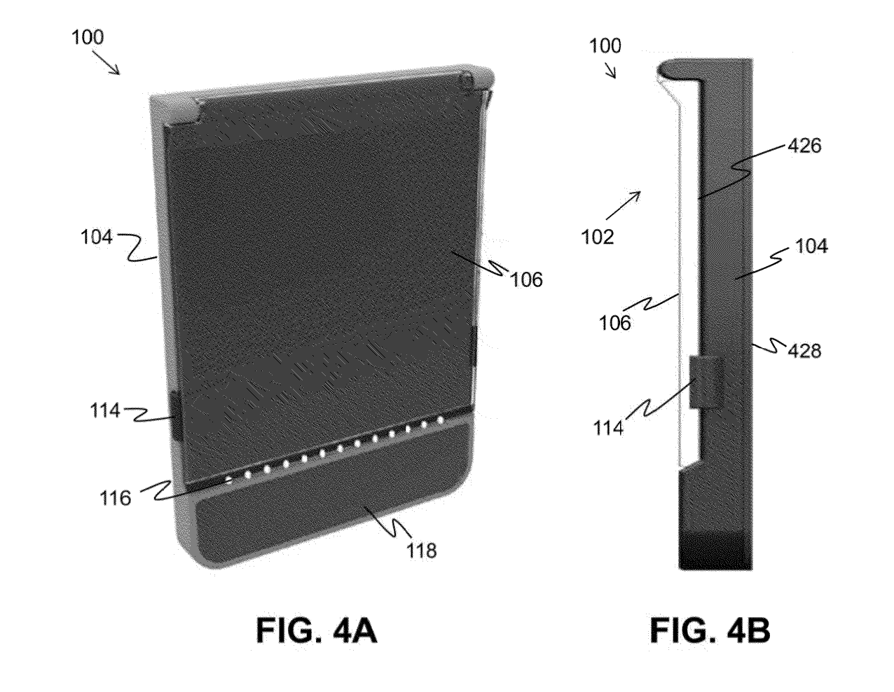

Referring to FIGS. 4A and 4B, a perspective view and side view of alert sign 100 are shown respectively. With reference to FIG. 4B, a sealing hardware 426 such as a gasket or seal may be included on all or part of surfaces about cover or lid 106 or an area of housing 104 around the periphery of inner volume 110 so as to protect informational signs, text, and graphics 112 and other features in inner volume 110 from the elements or weather. Alert sign 100 may include a back surface 428 of housing 104. Back surface 428 may have features machined thereon and therein (not shown) to facilitate attachment to mounting hardware.

Alert sign 100 may be of any size. In one embodiment, alert sign 100 is of a size large enough to be readily noticeable. In another embodiment, alert sign 100 has a significantly thin profile as to reduce weight so as to not strain a part of a building when alert sign 100 is mounted on a portion of a building. In another embodiment, alert sign is large enough such that inner volume 110 is significantly large enough to hold pet informational signs, text, and graphics 112 in a size large enough to be easily read and viewed by emergency personnel in emergency equipment and uniforms. In another embodiment, alert sign is of a size and thickness easily transportable by emergency personnel, such that an emergency personnel may carry alert sign 100 when searching for a pet during an emergency situation.

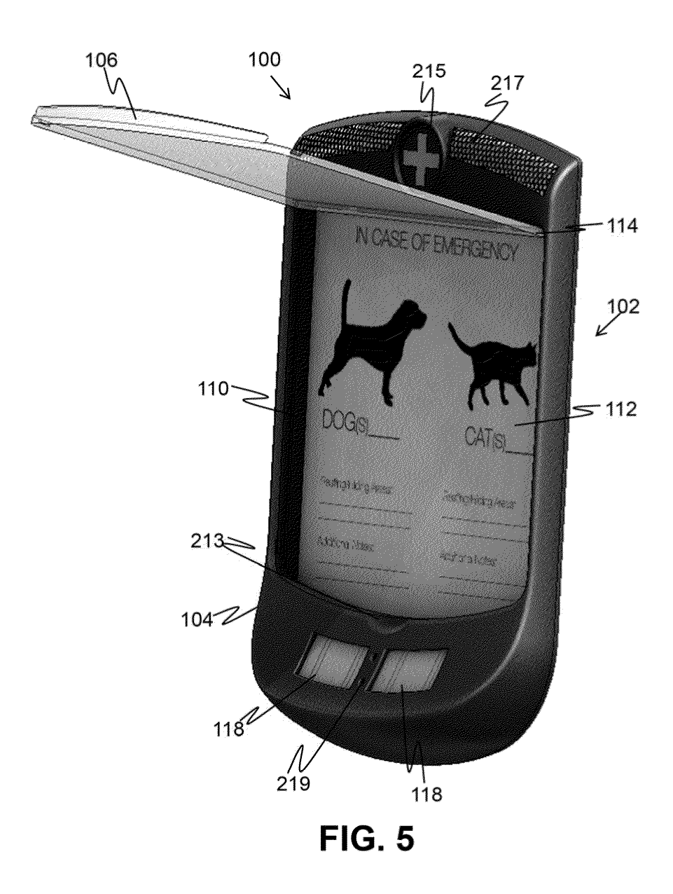

FIG. 5. Illustrates a perspective view of an example embodiment alert sign 100. Lid 106 is shown in an open position allowing access to inner volume 110. In one embodiment, a connection hardware 114 between lid 106 and housing 104 may be integrated into housing 104. For example, lid 106 may have tabs that fit into apertures in housing 104 (not shown) securing lid 106 to housing 104 and allowing lid 106 to rotate relative to housing 104.

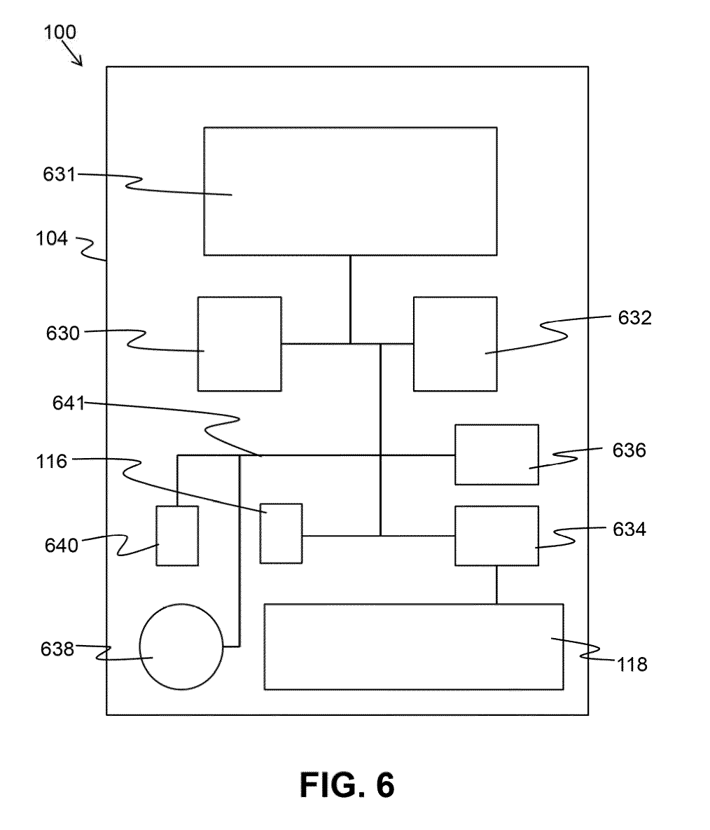

FIG. 6 illustrates a schematic view of alert sign 100. Various components may be located within housing 104, inner volume 110, and on a surface of housing 104. Components may be placed on or within housing 104 depending on each components function. Alert sign 100 may contain a CPU/memory unit 630 for processing and storing programs and executing other functions. CPU/memory unit 630 may operatively connect to other electrical components of alert sign 100 by circuit 641. Circuit 641 may be used to interconnect a select group or all electrical components of alert sign 100. Alert sign 100 may also include transceiver (TX/RX) 632 for transmitting and receiving remote signals. Battery 634 may be used to power electrical components of alert sign 100 in addition to storing energy generated by PV panel 118. An additional power source 636 may be used to provide additional power beyond battery 634 and energy created by PV panel 118. Alert sign 100 may include a transducer 638 such as a speaker or a microphone for outputting and amplifying input voice signals, real-time sounds, real-time messages, and for outputting pre-recorded messages stored by CPU/memory unit 630. Sound signals from transducer 638 may be transferred to CPU/memory unit 630 for further processing. Alert sign 100 may also include switch 640 for controlling the illumination of lighting devices 116 as well as controlling other electrical components of alert sign 100.

CPU/memory unit 630 may be used to store and process programs related to alert sign 100. CPU/memory unit 630 may be used along with TX/RX 632 and speaker 638 to process real-time remote communications. CPU/memory unit 630 may be used to output electronic informational signs, text, and graphics 112 to an electronic display 631 such as an LCD or LED display located within inner volume of housing 104. In one embodiment, a pet owner may be able to communicate directly with emergency personnel via speaker/microphone 638 on alert sign 100 via a cell phone during an emergency situation. In another embodiment, a pet vocalization such as a bark may be broadcast from a microphone within the house or from a microphone on a pet collar to speaker/microphone 638 to alert emergency personnel that there is a living pet within a building during an emergency situation. In another embodiment, a pre-recorded instruction may be continually output from speaker 638, or play at selected intervals to provide emergency personnel instructions during an emergency situation. In another embodiment, an emergency tone or sound may be broadcast from speaker/microphone 638 to alert an emergency personnel as to the presence and location of alert sign 100 (i.e. to draw attention to alert sign 100). CPU/memory unit 630 may retain information such that a low power/no power state of alert sign 100 does not erase pre-recorded information and programs. CPU/memory unit 630 may be any CPU/memory unit common in the art such as: a microprocessor, a microcontroller, an integrated circuit (IC), and the like. CPU/memory unit 630 may be programmed for additional functionality.

In addition to facilitating real-time communications, TX/RX 632 may also integrate with smart house technology to facilitate functionality of alert sign 100. In one embodiment, a smoke detector or alarm system detecting an emergency event may send a signal to TX/RX 632 for further processing by CPU/memory unit 630. TX/RX 632 may also be used in conjunction with animal embedded radio frequency identification (RFID) tags, pet GPS collars, and the like to more easily locate pets and ascertain the pet's exact location. TX/RX 632 may also be used to alert a user or emergency service of an emergency event, i.e. by sending a text message or pre-recorded message to a user's cell phone if an emergency signal has been received by alert sign 100. In addition to an alarm system broadcasting an emergency signal to alert sign 100, various intermediary devices may also be capable of transmitting signals to, and receiving signals from alert sign 100. For example, a hub or computer network may be operable to detect and sense environmental conditions, and send a signal to TX/RX 632 on alert sign 100 in response to a detected or sensed condition such as sensing smoke itself, or sensing a smoke alarm noise. TX/RX 632 on alert sign 100 may be operable to transmit and receive signals from a TX/RX 632 on another alert sign 100 such that an emergency signal or triggering event broadcast to a first alert sign 100 may also be further broadcast to a second alert sign 100. For example, multiple alert signs 100 may be interconnected as a network. CPU/memory unit 630 and TX/RX 632 on each alert sign 100 may be uniquely addressable, so as to define a network. For example, a user on vacation may choose to selectively network a first alert sign 100 in the user's house with a second alert sign 100 in a neighbor's house, such that any alert signal/triggering event received by TX/RX 632 on alert sign 100 in the user's house may be transmitted to, and received by TX/RX 632 on alert sign 100 in the neighbor's house to make the neighbor aware of an alert signal/triggering event in the user's home via the neighbor's alert sign 100.

Battery 634 may be used to provide power to various electrical components of alert sign 100. In one embodiment battery 634 is rechargeable and stores power generated by PV panel 118. In another embodiment, battery 634 is a conventional battery that provides energy in addition to PV panel 118.

Additional power source 636 may be used in addition to battery 634 for powering the electrical components of alert sign 100. In one embodiment, additional power source 636 may be hardwired to run a typical AC line voltage or use a transformer to convert the AC line voltage to a DC voltage. In one embodiment, additional power source 636 may be a jack for connecting a wire from an external power source such as an AC line voltage or DC transformed voltage to alert sign 100. In another embodiment, additional power source 636 may be a jack used to connect to a DC transformer. In another embodiment, additional power source 636 may be a backup battery.

In one embodiment, switch 640 is used to control the illumination of lighting devices 116. In one embodiment, switch 640 is photo sensor 219 used to detect light and illuminates lighting devices 116 at dusk, sundown, and at night when light levels are low. In one embodiment, switch 640 may be used in conjunction with CPU/memory unit 630. In another embodiment, CPU/memory 630 unit replaces switch 640. CPU/memory unit 630 may be used to control the illumination of lighting devices based on pre-programming, a sensing event from switch 640, or a signaling event from TX/RX 632. For example, in one embodiment, CPU/memory unit 630 may illuminate lighting devices 116 at a higher intensity, illuminate lighting devices 116 in a different color from normal (e.g. red instead of white), flash (strobe) lighting devices 116, or any combination thereof when an emergency signal is sensed. In another embodiment, switch 640 may be conventional switch that may be actuated to turn on and turn off power to alert sign 100, such as a rocker switch, a toggle switch, a slide switch, and a dimmer switch.

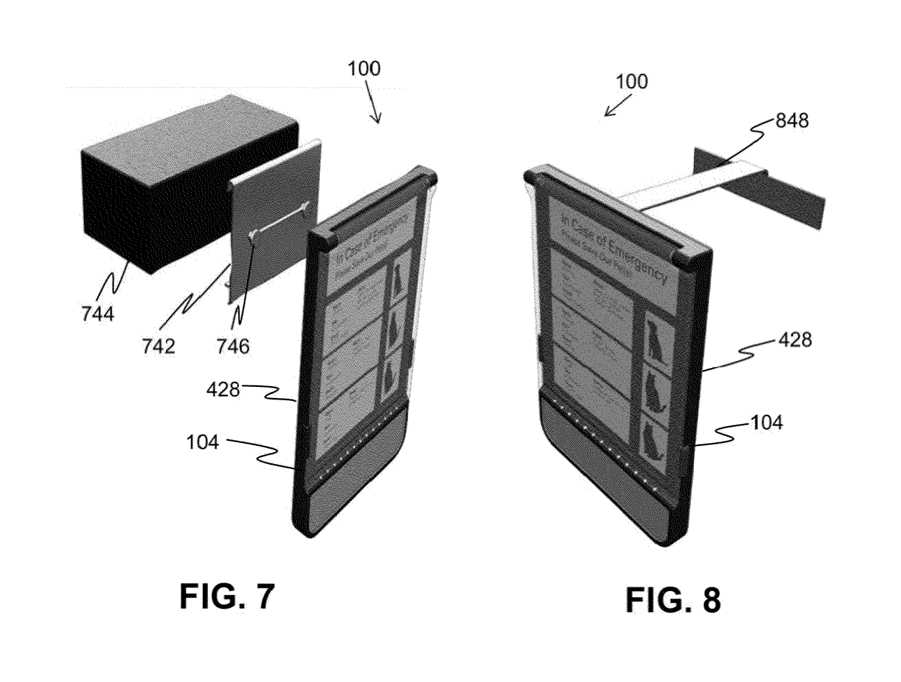

With reference to FIGS. 7, 8, 9A, 9B, 10A, 10B, 10C, and 11, these figures all illustrate different mounting embodiments of alert sign 100.

Referring to FIG. 7, an embodiment with alert sign 100 mounted to a brick 744 of a building is illustrated. Back surface 428 of housing 104 may include features such as a keyhole/buttonhole (not shown) to facilitate attachment with a corresponding key/button attachment 746 on brick bracket 742. Brick bracket 742 is fixedly attached to brick 744 as to facilitate the mounting of alert sign 100 to brick bracket 742 on a brick building or building of similar masonry such as stucco, block, poured concrete, stone, and the like.

Referring to FIG. 8, an embodiment with alert sign 100 mounted to a window bracket 848 is illustrated. Window bracket 848 is designed to attach to the back surface 428 of housing 104 so as to attach alert sign 100 to a window frame. Window bracket 848 may be designed to fit over the bottom of a window frame between the window frame and the window sash to allow full functionality of the window while also securing alert sign 100 to a building. Window bracket 848 may be adjustable to accommodate different sizes of window frames. Window bracket 848 may attach to the back surface 428 of housing 104 using previously described button/keyhole hardware, or similar mounting hardware such as a suction cup or hanger.

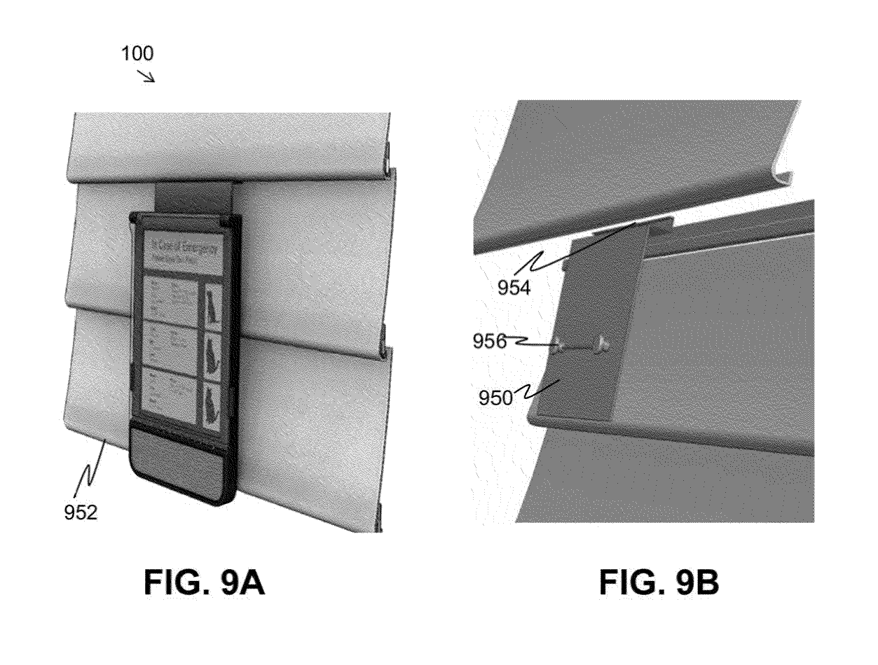

Referring to FIGS. 9A and 9B, embodiments illustrating alert sign 100 attached to building siding 952 and siding attachment bracket 950 are shown. Siding attachment bracket 950 may be designed to interface with the conventional, interlocking features common to building siding such as aluminum siding and vinyl siding. Siding attachment bracket 950 may include a lip 954 which interfaces with the interlocking design of siding 952. Siding bracket 950 may include attachment hardware such as a raised key/button 956 used to attach to corresponding features on the back surface (not shown) of housing 104.

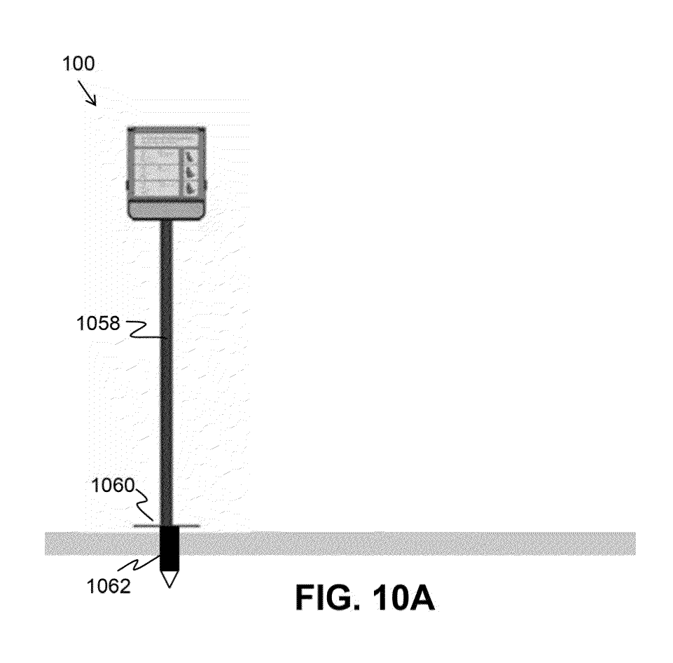

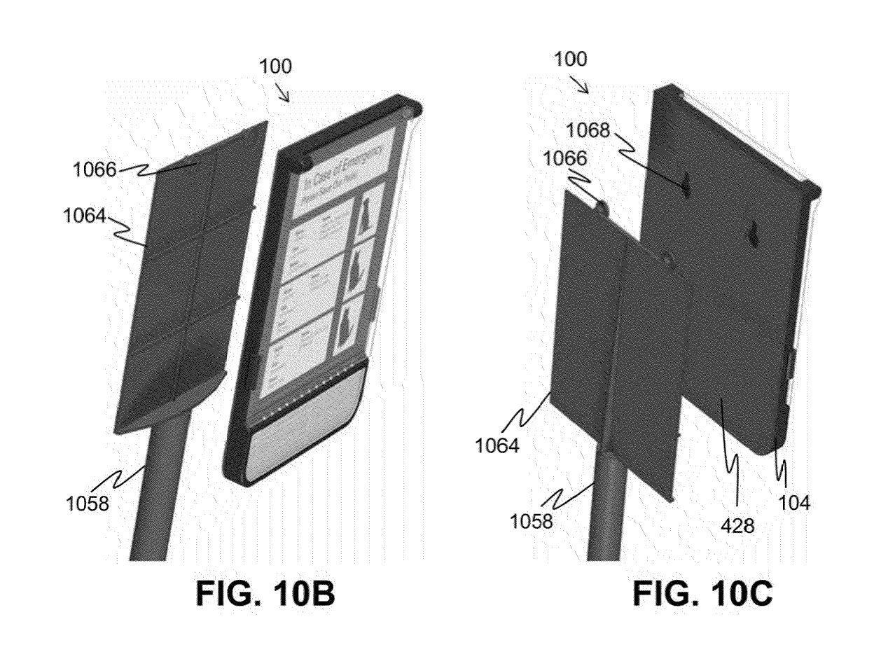

With reference to FIGS. 10A, 10B, and 10C, an embodiment showing alert sign 100 mounted to a post 1058 is shown. Post 1058 may include a foot push 1060 towards one end to facilitate driving a staked end 1062 into the ground. Staked end 1062 may be of varying length to provide stability based on ground conditions and post 1058 size. In one embodiment, a longer post 1058 and sandy soil conditions may require a longer staked end 1062 to provide a more stability to post 1058. Another end of post 1058 may include a mounting portion 1064 to facilitate the mounting of alert sign 100. Mounting portion 1064 may include raised key/button features 1066 to interconnect with buttonhole/keyhole features 1068 on back surface 428 of housing 104 on alert sign 100.

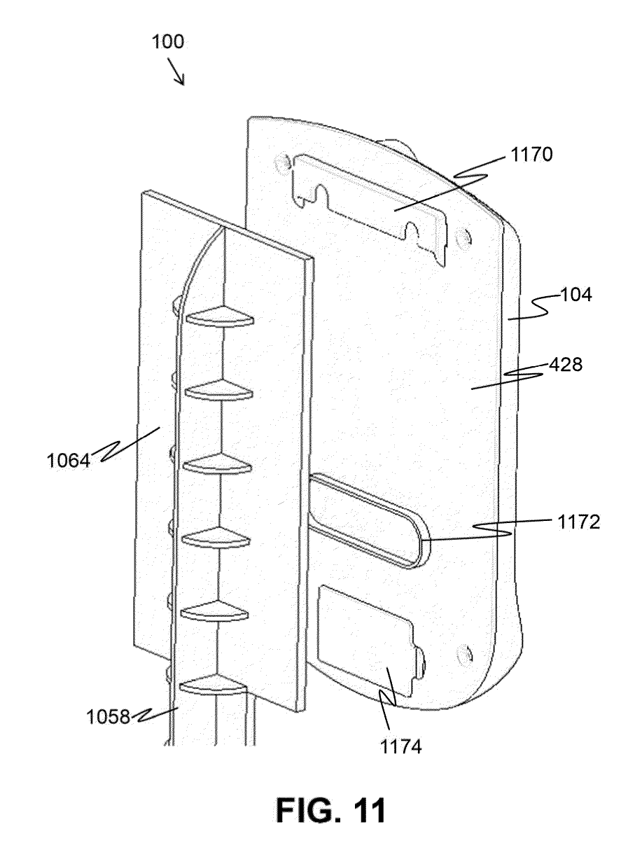

FIG. 11 illustrates a rear perspective view of another mounting embodiment of alert sign 100. Back surface 428 of housing 104 may include mounting hardware 1170 such as a bracket with notches for interfacing with and attaching to a corresponding external mounting hardware 1066 such as key/button features on mounting portion 1064 of post 1058. Mounting hardware 1170 may be selectively engageable to the housing such that the mounting hardware may be positioned on different areas of housing 104. For example, mounting hardware 1170 may be positioned attached to housing 104 via an adhesive, suction cup, press fitting, hook and loop fastener, and the like to selectively remove and position mounting hardware 1170 to different locations on housing 104. Mounting hardware 1170 may include, but is not limited: a bracket such as a sawtooth bracket or keyhole bracket; a recess such as an indentation or cavity machined into housing 104 and used to support an external hardware (e.g. a nail or screw attached to a wall for hanging thereon); a hanging wire; a suction cup; a hook and loop fastener; a D-ring; a hook; and the like, such that mounting hardware 1170 attaches either to a corresponding external mounting hardware, or directly to an external surface. Mounting hardware 1170 need not be limited to back surface 428 and may be located anywhere on housing 104 such as on transparent surface 106 (not shown).

Back surface 428 of housing 104 may include standoff 1172 to add stability when alert sign 100 is attached to mounting portion 1064. Back surface 428 may also include access panel 1174 for accessing components within housing 104 such as battery 634.

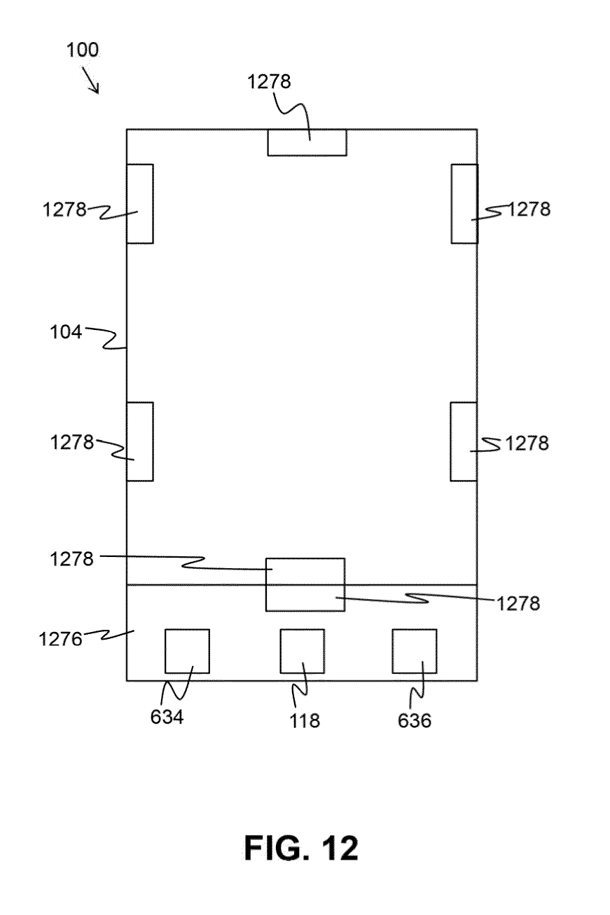

FIG. 12 illustrates an example modular power source connection for alert sign 100. Power source such as battery 634, additional power source 636, and PV panel 118, may be compartmentalized into a power package 1276 that may be selectively attachable and removable from alert sign 100. Power package 1276 may be modular, such that power package 1276 may be selectively removable from alert sign 100. Alert sign 100 and power package 1276 may comprise one or more modular power source connection hardware 1278 on a surface of housing 104 for connecting power package 1276 to a circuit (not shown) within alert sign 100 (not shown) such that power package may be repositioned to different locations on alert sign 100, relative to modular power source connection hardware 1278. Modular source connection hardware 1278 may be a contact, jack, or plug, such that a connection between a modular power source connection hardware 1278 on power pack 1276 and modular power source connection hardware 1278 on housing 104 allows power from power sources 634, 636, and 118 to be transferred to a circuit (not shown) within housing 104. Modular power package 1276 may also connect to alert signs 100 of different shapes and sizes via modular power source connection hardware 1278, and provide different modular power source configurations based on location, requirements, etc. (e.g. power package 1276 may include only a jack 636 for connection to a line voltage if alert sign 100 is located near an electrical outlet, but power package 1276 may comprise any combination of power sources 634, 636, and 118).

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner co-extensive with the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed is:

1. An illuminated alert display comprising:
a housing, the housing comprising a display portion thereon, the display portion operable to affix at least one of text and graphics thereto;
a lighting device operatively connected to the housing,
a power source operatively connected to the lighting device; and
mounting hardware operatively connected to the housing.

2. The illuminated alert display of claim 1, wherein the housing further comprises an inner volume, the display portion located within the inner volume; wherein the housing further comprises a transparent surface overlying the inner volume, such that at least one of the text and the graphics within the inner volume are visible through the transparent surface of the housing.

3. The illuminated alert display of claim 2, wherein the transparent surface of the housing comprises attachment hardware to selectively engage the transparent surface to the housing such that the transparent surface may be selectively removed from the housing to provide access to at least one of the text and the graphics within the inner volume.

4. The illuminated alert display of claim 1, wherein the lighting device further comprises a first lighting device and a second lighting device, and wherein the first lighting device is operable to illuminate at least one of the text and the graphics, and wherein the second lighting device is operable to direct illumination away from the housing.

5. The illuminated alert display of claim 1, wherein the power source is at least one of: a wired power source operable to provide a line voltage to the illuminated alert display via connection to an electrical outlet; a battery; a rechargeable battery; and a photovoltaic panel.

6. The illuminated alert display of claim 1, wherein the power source is selectively engageable to the housing via a modular power source connection hardware such that the power source is selectively positionable on different portions of the housing via a connection to the modular power source connection hardware.

7. The illuminated alert display of claim 1, wherein the mounting hardware is selectively engageable to the housing such that the mounting hardware may be positioned on different areas of the housing, the mounting hardware comprising at least one of: a bracket; a recess; a hanging wire; a suction cup; a hook and loop fastener; a D-ring; and a hook, such that the mounting hardware attaches either to a corresponding external mounting hardware, or directly to an external surface.

8. An alert sign comprising:
a housing, wherein the housing comprises an inner volume, the inner volume operable to house at least one of a graphic and a text, the housing further comprising a transparent surface overlying the inner volume such that at least one of the graphic and the text within the inner volume of the housing is visible from outside the housing through the transparent surface, and wherein the transparent surface is selectively engageable to the housing via a connection hardware, such that the connection hardware allows the transparent surface to be selectively removed from the housing to allow access to the inner volume;
a lighting device connected to the housing; the lighting device operable to illuminate at least one of: the inner volume of the housing, and an area external to the housing;
a power source operatively connected to the lighting device, wherein the power source is housed at least one of on and inside of the housing;
a circuit, wherein the circuit provides an electrical connection between the power source and the lighting device;
a switch, the switch operatively connected to the circuit, the switch operable to control power from the power source to the lighting device so as to control an illumination of the lighting device; and
a mounting hardware, the mounting hardware operatively connected to the housing and configured to visibly mount the display such that the sign and at least one of the graphic and the text within the inner volume is visible.

9. The alert sign of claim 8, wherein the connection hardware of the transparent surface comprises a hinged attachment, the hinged attachment operatively connected to the transparent surface and the housing.

10. The alert sign of claim 8, wherein the power source is at least one of: a battery; a rechargeable battery; and a photovoltaic panel.

11. The alert sign of claim 8, wherein the power source is selectively engageable to the housing via a modular power source connection hardware such that the power source is selectively positionable on different portions of the housing via a connection to the modular power source connection hardware.

12. The alert sign of claim 8, wherein the switch is at least one of: a rocker switch, a toggle switch, a slide switch, a dimmer switch, and a photo sensor.

13. The alert sign of claim 8, wherein the mounting hardware is selectively engageable to the housing such that the mounting hardware may be positioned on different areas of the housing; the mounting hardware at least one of: a bracket; a recess; a hanging wire; a suction cup; a hook and loop fastener; a D-ring; and a hook, such that the mounting hardware attaches either to a corresponding external mounting hardware, or directly to an external surface.

14. An alert sign comprising:
a housing, the housing comprising an inner volume, the inner volume operable to display at least one of a graphic and a text, the housing further comprising a transparent surface overlying the inner volume such that at least one of the graphic and the text within the inner volume of the housing is visible from outside the housing through the transparent surface, and wherein the transparent surface is attached to the housing by an attachment hardware such that the transparent surface is selectively removable from the housing so as to allow access to the inner volume;
a lighting device operatively connected to the housing, the lighting device operable to illuminate at least one of: the inner volume of the housing, and an area external to the housing;
a power source operatively connected to a circuit, wherein the power source is housed at least one of on or inside of the housing;
a circuit, wherein the circuit interconnects at least the power source, the lighting device, a switch, a processor, a transceiver, and a speaker;
a switch, the switch operatively connected to the circuit, the switch operable to control power from the power source to the lighting device so as to control an illumination of the lighting device;
a processor, the processor operatively connected to the circuit, the processor further comprising a memory, wherein the processor and the memory are operable to store and execute one or more program embedded on any processor readable medium;
a transceiver, the transceiver operable to at least one of transmit and receive a signal;
a speaker, the speaker configured to output an audio signal;
a mounting hardware, the mounting hardware operatively connected to the housing and configured to visibly mount the display such that at least one of the graphic and the text within the inner volume is visible when the alert sign is mounted, wherein the mounting hardware is selectively engageable to the housing such that the mounting hardware may be positioned on different areas of the housing, the mounting hardware comprising at least one of: a bracket; a recess; a hanging wire; a suction cup; a hook and loop fastener; a D-ring; and a hook, such that the mounting hardware attaches either to a corresponding external mounting hardware, or directly to an external surface.

15. The alert sign of claim 14, wherein at least one of the transparent surface and the housing further comprises a sealing hardware on a portion thereof, the sealing hardware operable to provide a weatherproof barrier between the transparent surface and the housing so as to weatherproof the inner volume.

16. The alert sign of claim 14, wherein the transparent surface further comprises a lock, the lock operable to lock the transparent surface relative to the housing to prevent selective removal of the transparent surface relative to the housing and prevent access to the inner volume.

17. The alert sign of claim 14, wherein the power source is at least one of: a battery; a rechargeable battery; and a photovoltaic panel.

18. The alert sign of claim 14, wherein the power source is selectively engageable to the housing via a modular power source connection hardware such that the power source is selectively positionable on different portions of the housing via a connection to the modular power source connection hardware.

19. The alert sign of claim 14, wherein the transceiver operable to at least one of transmit and receive a signal from at least one of: an alarm system, a computer network, a cell phone, a pet transmitter, and another alert sign.

20. The alert sign of claim 14, wherein the processor executes the one or more programs in response to the signal received from the transceiver.
